(19) United States
(12) Patent Application Publication
(10) Pub. No.: US 2008/0019461 A1
(43) Pub. Date: Jan. 24, 2008

(54) Receiving a Signal in a Communication System

(76) Inventors: Alberto Rabbachin, Oulu (FI); Ian Oppermann, Espoo (FI)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/596,796

(22) PCT Filed: May 18, 2005
(86) PCT No.: PCT/FI05/50167

§ 371 Date: Jun. 1, 2007

(30) Foreign Application Priority Data
May 19, 2004 (FI) 20040700

(51) Int. Cl. H04B 7/26; H04L 27/06; H04L 7/00

(52) U.S. Cl. 375/316; 375/354; 375/355; 455/39

(57) ABSTRACT

The invention relates to a method of receiving a time modulated signal in a communication system. The method comprises steps of receiving the signal non-coherently, integrating the received signal by at least two integrators, the at least two integrators being delayed in time with respect to each other, comparing energies received by the at least two integrators and determining synchronization with the signal based on comparison of output values of the at least two integrators.

### FIELD OF THE INVENTION

The invention relates to a method and a receiver for receiving a signal in a communication system. The invention especially relates to a low complexity receiver receiving the signal non-coherently.

### BACKGROUND

Ultra Wideband (UWB) is a very promising technology for future short-range indoor data communications applications. UWB can be defined such that a radio system is a UWB system if the fractional bandwidth B_{f} (defined as the ration between the −10 dB bandwidth of the signal and its centre frequency) is greater than 20% or greater than 500 MHz. The UWB concept can be implemented with or without a carrier signal, and can be based on time-hopping (TH), direct-sequence (DS) spread spectrum approaches, fast frequency sweeping, or multi-carrier techniques. The data modulation schemes most often used in UWB systems are pulse position modulation (PPM) and pulse amplitude modulation (PAM).

As a UWB signal can be a base-band signal processing system, the analogue front-end complexity can be substantially lower than in traditional carrier-based radio systems. This makes devices of very low complexity, low power consumption and low costs possible.

Low data rate sensor networks providing location and tracking services are an interesting application for UWB technology. It is known that a high spatial resolution can be achieved using UWB due to the extreme wideband nature of the signal. The generation of positioning information from the time domain UWB signal leads to a substantial increase in system complexity. In order to minimize the complexity of the sensors, location information can be derived by multiple fixed network nodes. These nodes can detect the time of arrival of the UWB signal from network sensors and exchange information to determine the position.

The UWB sensor devices are required to receive commands from the fixed “master” network and send the requested information using a UWB signal. All the computational issues associated with position calculation are left to the central system. The low complexity requirement of the sensor means that simple solutions are preferred. A classical Rake receiver approach can lead to high receiver complexity due to the large number of fingers required to collect energy from the rich multipath channel. A high-speed precision clock may also be required.

Bit synchronization is an important issue in UWB, as in any communication system. The scope of the bit synchronization stage is to find the starting point of the received signal. The accuracy of the synchronization is bounded by the clock frequency of the receiver. The typical synchronization procedure used in wireless communication, for instance, is based on the correlation of the received signal with a locally generated signal. Narrowband systems can use a pilot tone to help the receiver to find the phase of the received signal. Wideband systems based on the spreading of the transmitting signal achieve bit synchronization by the despreading procedure.

In an energy collection receiver, correlation based procedures would require adding a correlation block only dedicated to the synchronization stage, thereby compromising the low complexity of the receiver.

### BRIEF DESCRIPTION OF THE INVENTION

An object of the present invention is thus to provide a method and an apparatus for implementing the method so as to overcome the above-mentioned problems. The objects of the invention are achieved by a method of receiving a time modulated signal in a communication system. The method comprises steps of receiving the signal non-coherently, integrating the received signal energy by at least two integrators, the at least two integrators being delayed in time with respect to each other, comparing output values, each output value corresponding to the received energy in the integrator, of the at least two integrators, and determining synchronization with the signal based on comparison of output values of the at least two integrators.

In one aspect of the invention there is provided a receiver in a communication system. The receiver comprises means for receiving a signal non-coherently, at least two integrators for integrating energy of the received signal, the at least two integrators being delayed in time with respect to each other, means for comparing output values, each output value corresponding to the energy received in the integrator, of the at least two integrators, and means for determining synchronization with the signal based on the comparison of the output values of the at least two integrators.

The invention thus relates to the reception of a signal in a communication system. The communication system can be a wired/fixed or wireless system or network. One example of such a wireless communication system is the UWB system. UWB is mentioned here only as one example of a system to which the invention is applicable. The invention is also applicable to all systems providing non-coherent reception of a signal. In one embodiment, non-coherent reception means reception where a positive value of the signal is formed by squaring, taking an absolute value of the signal or by an envelope detector.

In the invention, the signal is time modulated. In one embodiment this means that the signal includes time slots. For instance, an information bit may be divided into M time slots to perform M-ary modulation. In one embodiment, signal energy is placed into an appropriate time slot. For instance, in case of two time slots, placing signal energy in the first time slot means that the information bit to be transmitted could be ‘0’, and placing signal energy in the second timeslot would mean that the transmitted bit is ‘1’.

In the invention, the signal is received by at least two integrators that are delayed in time with respect to each other. This means that the starting points of the at least two integrators are not the same. The integrators collect energy from the received signal. The energies received by the integrators are converted to output values of the integrators. The output value can be a voltage level, for instance. In the invention, the output values of the integrators are compared. Furthermore, in the invention, synchronization with the signal is determined by the comparison of the output values of the at least two integrators. In one embodiment, synchronization is determined so that the starting point in time of the integrator giving the highest output value is determined to give the proper synchronization moment.

In one embodiment, synchronization with the signal is based on a preamble sent in the signal. The preamble can include a predetermined number of same information bits such as 100 zeroes. The preamble detection and synchronization can take place parallel in the receiver. The preamble detection can be performed such that a predetermined threshold is set for the integrator comparisons in order to conclude the preamble to have been detected. The predetermined threshold can be a winner index or a cumulative sum index, for instance. The winner index defines how often a certain integrator has been a winner in the comparison of the integrators. The cumulative sum index calculates a cumulative sum of the output values given by the integrators. If the predetermined threshold has been exceeded, the receiver can conclude that the preamble has been detected, and thus, synchronization in the receiver has been achieved.

The invention provides the advantage that good synchronization with a time modulated signal can be achieved in a receiver.

### BRIEF DESCRIPTION OF THE DRAWINGS

In the following, the invention will be described in greater detail by means of preferred embodiments with reference to the attached [accompanying] drawings, in which

FIG. 1 shows one example of a system according to the invention;

FIG. 2 shows one embodiment of a method according to the invention;

FIG. 3 highlights the integrating principle according to an embodiment of the invention;

FIG. 4 shows one embodiment of an apparatus according to the invention.

### DETAILED DESCRIPTION OF THE INVENTION

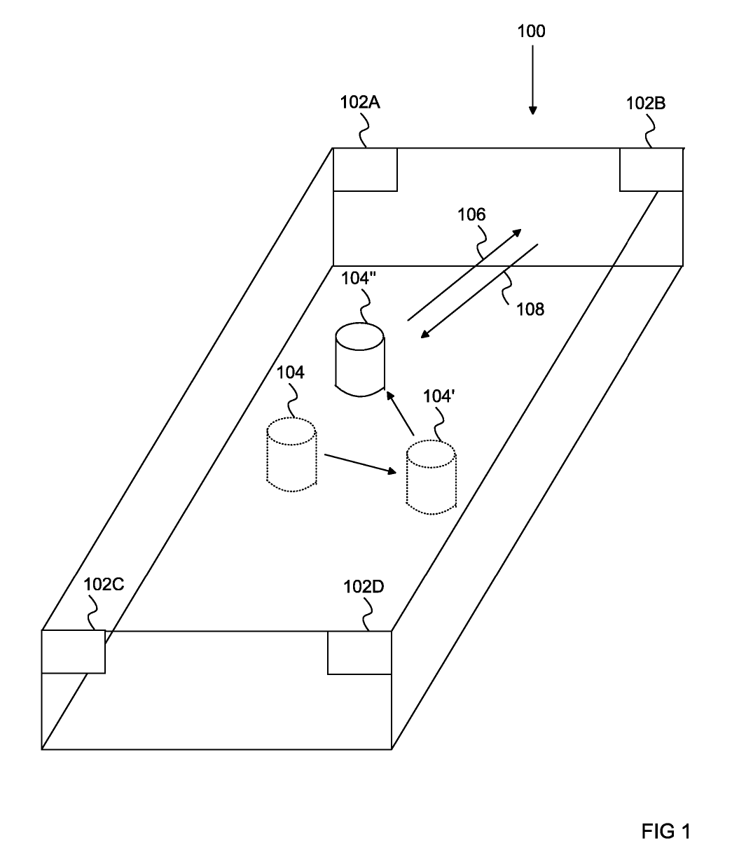

FIG. 1 illustrates one embodiment of a system 100 according to the invention. The system shown in FIG. 1 is based on a centralized control to provide low costs, low complexity and low power consumption for the mobile system devices, such as a device 104. A number of base stations 102A to 102D periodically exchanges small amounts of information with the device 104, which can be a UWB tag, for instance. The base stations track the position of the UWB tags within the network area. FIG. 1 illustrates how the device has moved along the route 104->104′->104″. The MAC (Medium Access Control) solution can also be of low complexity. In one embodiment, Time Division Multiple Access (TDMA) can be used for the medium access. The system can also use Time Division Duplex (TDD). There can be an uplink “talk” time frame where, based on the time slot assignments, the tags can send information to the base stations and a downlink “listen” time frame where the UWB tags can receive commands and information from the central system. Each of these two time frames can include a beacon that brings information on the presence of the network and on the structure of the network. In one embodiment, the frame duration is divided into time slot units and a number of consecutive slots is assigned to the UWB tag to compose a message.

The TDMA system can have an aggregate data rate of 5 Mbit/s, which may be divided amongst the numerous devices. Considering the per device data rate target of several Kbit/s, there may be thousands of devices in the system. The number of devices in the system can be very flexible. Each UWB tag must know the network data rate and the location of the “beacon” signal. All the other information on the communication frame structure can be contained in the beacon. The beacon can contain a synchronization component and a data component. The synchronization component can contain a preamble for bit synchronization and a bit sequence for slot synchronization. The preamble used for synchronization can also be used to detect the presence of the network. When the synchronization procedure is completed, the remaining part of the beacon can include information that permits the tag to know the structure and the rules of the network.

For coverage and positioning reasons several base stations define the back-bone of the network. Each base station based on time division can send a beacon at the beginning of each frame. Perfect synchronization between base stations does not produce interference during the beacon sending. Once the tag recognizes the presence of the network and achieves synchronization with one of the beacons, it does not listen to the other beacons anymore. When the central system has to send commands or information to a single tag, it can use the base station that sent the beacon utilized by the tag. Vice versa, in the uplink 106 the signal transmitted from the tag is received by several base stations in order to post-process the received signal to achieve positioning.

The commands sent through the base stations can be: dump memory, memory update, slot reallocation and positioning. The beacon can be used to broadcast to the whole network. The information sent by the UWB tags can relate to the command received from the base station. In the case of missed communication in downlink, the UWB tag can restart from the synchronization procedure. Each single tag can leave the network at any moment, letting its assigned slot free for a new tag. The central system can dynamically change the slot assignments.

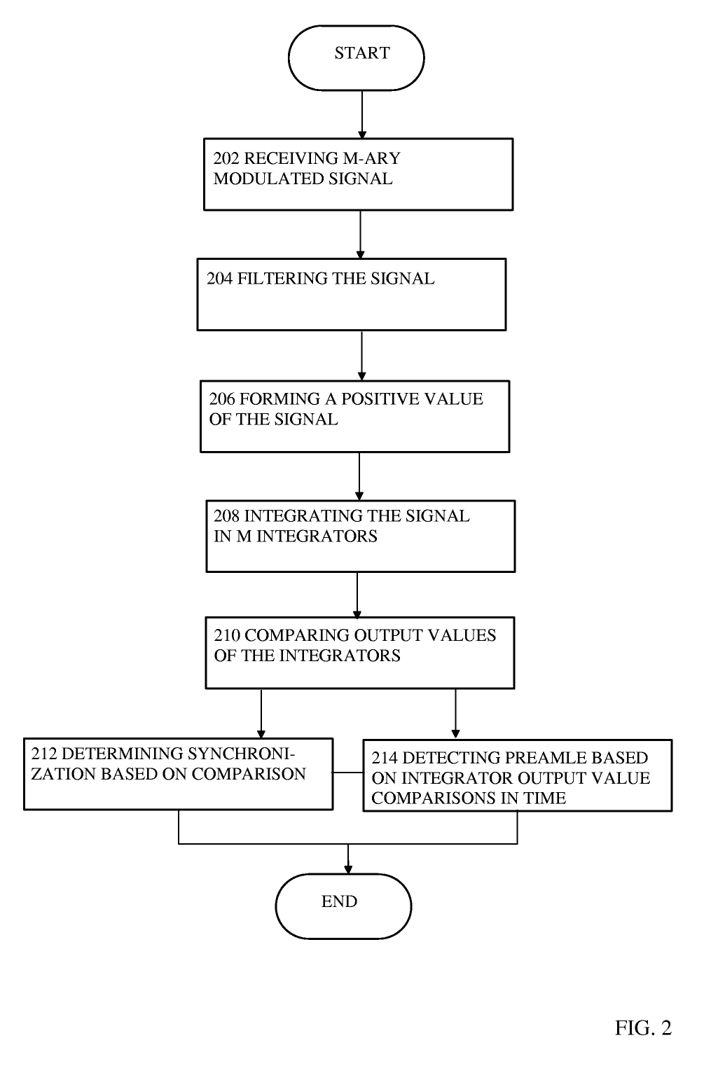

FIG. 2 shows one embodiment of the method according to the invention. The embodiment of FIG. 2 is explained in the following using UWB signal as an example. The UWB signal can be based on a train of short pulses multiplied by a spreading sequence using the Direct Sequence (DS) approach. In one embodiment, the signal energy is uniformly distributed within the time slot having signal energy. Signal energy can be distributed to the time slot having signal energy in the form of a continuous pulse train. Alternatively, there can be spaces between the pulses.

The information bit interval is divided into M time slots. This modulation is called M-ary Bit Position Modulation (M-BPM). As the detection procedure is based on energy collection, the separation of different users can only be done in time domain. We consider here a single user case. The transmitted signal is given by:

$$s ( t ) = {\sum }_{k = - ∞}^{∞} {\sum }_{j = 0}^{N - 1} {w}_{tr} ( t - k {T}_{b} - j {T}_{c} - {T}_{s} {d}_{k} ) {( {c}_{p} )}_{j} , \qquad ( 1 )$$

where

wₜᵣ(t) is the transmitted pulse with length Tₚ,

T_{b} is the symbol interval,

Tₛ is a time shift used to distinguish the different symbols,

dₖ68 [0, . . . , M−1] is the transmitted symbol,

T_{c}=NTₚ, with N integer, is the chip interval and

(cₚ)ⱼ is the j^{th} chip of the pseudo-random (PR) code.
The PR code is bipolar with values {−1, +1}. It can be assumed to be the same for all the users since it has solely a spectrum randomizing effect. The data rate is defined as R_{d}1/T_{b}=1/(MTₛ). The received signal according to step 202 in FIG. 2 after the Rx antenna is given by

$${s}_{r} ( t ) = {\sum }_{i = 0}^{L} {A}_{i} {\sum }_{k = - ∞}^{∞} {\sum }_{j = 0}^{N} {w}_{rx} ( t - k {T}_{b} - j {T}_{c} - {T}_{s} {d}_{k} - {τ}_{i} ) {( {c}_{p} )}_{j} + n ( t ) , \qquad ( 2 )$$

where wᵣₓ(t) is the 1^{st} derivative of wₜᵣ(t), L is the number of resolvable paths, Aⱼ and τᵢ define the gain and the delay for the i^{th} path and n(t) is zero mean additive Gaussian noise.

Step 204 in FIG. 2 discloses filtering of a signal, which filtering can be band-pass filtering, for instance. In step 206, a positive value of the filtered signal is formed. The positive value is formed by squaring, taking an absolute value of the signal or by an envelope detector, for instance. Step 208 discloses the integration of the signal. The system uses time orthogonal modulation. For M-BPM modulation, the receiver utilizes M integrators, which can be evenly spaced over the symbol period, to detect the received energy in M time-slots.

$${D}_{m} = {\int }_{{\hat{t}}_{sync} + m {T}_{b} / M}^{{\hat{t}}_{sync} + ( m + 1 ) {T}_{b} / M} {( {s}_{r} ( t ) )}^{2} ⅆ t , \qquad ( 3 )$$

where \hat{t}_{synch} is the integration starting point for the 1^{st} integration time slot. The receiver then compares the output values of the integrators according to step 210 and then selects the maximum of all the integrator outputs according to method phase 212.

$${\hat{d}}_{k} = {max}_{m} ( {D}_{m} ) \qquad ( 4 )$$

In order to maintain the low complexity nature of the receiver, the synchronization stage can also be based on the energy collection approach. A parallel search is performed and a maximum output is selected. Synchronization can be made using a preamble of N_{bit} bits of all ‘0’.

Method step 214 illustrates the detection of the preamble in the receiver. In one embodiment, the receiver counts a cumulative sum for the integrator output value. For instance, in the case of 8 integrators the values of their outputs after the first integration could be (10, 1, 1, 3, 4, 5, 1, 3). Of these output values it can be seen that the first integrator, giving the highest output value, is the temporary winner for the first information bit. Then, when integrating the second information bit, let the outputs of the integrators be (8, 10, 4, 5, 8, 3, 2, 1). For these values the temporary winner is the second integrator. If the preamble includes 100 bits, for instance, above-disclosed integration is also repeated 100 times. At the end of 100 bits we have the cumulative output values, that is the sum of bit-specific output values for each integrator (1000; 300; 200; 400; 350; 500; 300; 200). In this case, the integrator number one provides the highest cumulative output value and it can be concluded that the synchronization point is the integration starting point of the first integrator.

In one embodiment, a cumulative winner index can be calculated instead of or in addition to the above-disclosed cumulative output value. In the case of 8 integrators, there can be 8 indexes counting how many times each integrator has been the temporary winner.

The receiver can have a threshold value for the cumulative output value index and/or the winner index. In one embodiment, if the cumulative output value index exceeds a predetermined threshold, the receiver can conclude that the preamble has been detected, Accordingly, in another embodiment, if the cumulative winner index exceeds a predetermined threshold value, the receiver can conclude that the preamble has been detected, and correspondingly, synchronization has been achieved. In still one embodiment, the receiver can monitor both of these conditions, that is, that the cumulative output value index and the cumulative winner index both exceed their respective threshold values. Besides using the cumulative output value index and/or the cumulative winner index, the receiver can also use another corresponding index that is obtainable from the information available.

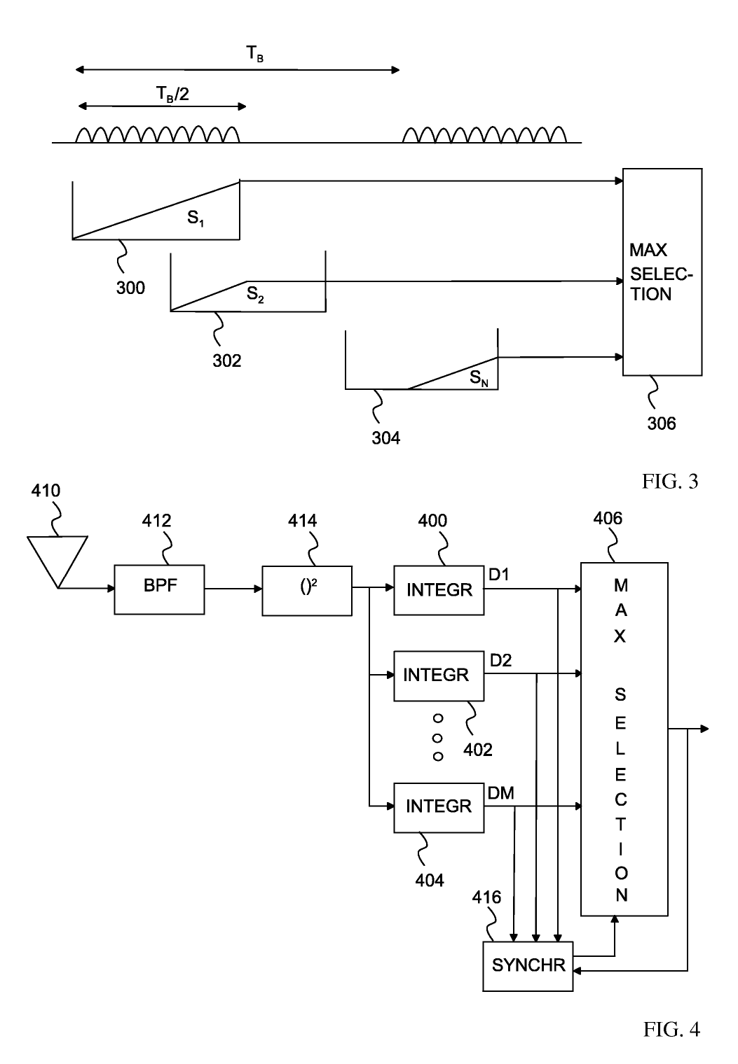

FIG. 3 highlights one embodiment of the invention. The received information bit has a duration T_{b}. The system uses two timeslots, each having duration of T_{b}/2. The information received includes two zeroes ‘0’ since signal energy is placed in the first timeslots. The receiver contains three integrators 300, 302 and 304 of equal lengths. The lengths of the integrators equal to the length of timeslot thus being T_{b}/2. It can be seen that the integrators 300 and 302 partly overlap each other in time. The integrators in the receiver can also be next to each other. In the receiver, the number of integrators equals or is greater than the number of timeslots. The more integrators there are, the more precise synchronization the receiver can achieve. In FIG. 3, the first integrator is synchronized with the signal and is able to collect all the energy S₁ transmitted in the timeslot. Integrators 302 and 304 are not synchronized with the signal and are not able to collect all energy of the timeslot.

The integrators give as the output value a voltage level, for instance. The voltage levels from different integrators are inputted to a selector 306, which selects the highest output value. In FIG. 3, the first integrator 300 provides the highest output value.

FIG. 4 illustrates one embodiment of a receiver according to the invention. The receiver includes an antenna 410 for receiving a signal. The received signal is filtered in filtering means 412, which can be a band-pass filter, for instance. The filtered signal is forwarded to positive making means 414, which can make the signal positive by taking an absolute value, squaring or a corresponding manner. The positive signal is directed to the integrators 400 to 404 of the receiver. There have to be at least two integrators in the receiver in order to receive a time-modulated signal. The integrators are delayed in time in comparison with each other. In an embodiment, the integrators are so placed at the time axis that they cover the whole information bit interval. The integrators can be overlapping or next to each other. The receiver also includes means for comparing 406 output values of the at least two integrators. The comparing means 406 can be connected to synchronizing means 416. The synchronizing means can be configured to perform several tasks, such as counting the winner index of the integrators, counting the cumulative output value index of the integrators, comparing the indexes with predetermined threshold values and deciding whether synchronization has been achieved based on the comparisons, for instance.

The invention can be implemented in the receiver as software, application specific integrated circuit (ASIC), logic components or a corresponding manner.

It will be obvious to a person skilled in the art that as the technology advances, the inventive concept can be implemented in various ways. The invention and its embodiments are not limited to the examples described above but may vary within the scope of the claims.

1. A method of receiving a time modulated signal in a communication system, the method comprising:
receiving the signal non-coherently;
integrating the received signal energy by at least two integrators, the at least two integrators being delayed in time with respect to each other;
comparing output values, each output value corresponding to the received energy in the integrator, of the at least two integrators;
determining synchronization with the signal based on comparison of output values of the at least two integrators.

2. A method as claimed in claim 1, wherein the at least two integrators are arranged in time to cover the duration of the signal.

3. A method as claimed in claim 1, wherein synchronization with the signal is determined such that the synchronization point in time is the starting point of the integrator giving the highest output value of the integrators.

4. A method as claimed in claim 1, wherein the time modulated signal includes at least two time slots per each information bit.

5. A method as claimed in claim 4, wherein the number of integrators at least equals the number of time slots.

6. A method as claimed in claim 4, wherein the time duration of each integrator belonging to the set of the at least two integrators equals to the time duration of the time slot.

7. A method as claimed in claim 4, wherein the value of the information bit is indicated by having signal energy in one of the at least two timeslots.

8. A method as claimed in claim 1, wherein the synchronization is done based on a preamble including a predetermined number of same information bits.

9. A method as claimed in claim 8, wherein the synchronization with the signal is concluded to exist when the preamble has been detected.

10. A method as claimed in claim 8, wherein the preamble is concluded to have been detected when a certain integrator has provided the highest output value during a predetermined number or bits more often than a predetermined threshold defines.

11. A method as claimed in claim 8, wherein the preamble is concluded to have been detected when one of the at least two integrators provides a cumulative output value sum index during a predetermined number of bits higher than a predetermined threshold.

12. A receiver in a communication system, wherein the receiver comprises:
means for receiving a signal non-coherently;
at least two integrators for integrating energy of the received signal, the at least two integrators being delayed in time with respect to each other;
means for comparing output values, each output value corresponding to the energy received in the integrator, of the at least two integrators;
means for determining synchronization with the signal based on the comparison of the output values of the at least two integrators.

13. A receiver as claimed in claim 12, wherein the at least two integrators are arranged in time to cover the duration of the signal.

14. A receiver as claimed in claim 12, wherein determining means is configured to determine synchronization with the signal such that the synchronization point in time is the starting point of the integrator giving the highest output value of the integrators.

15. A receiver as claimed in claim 12, wherein the time modulated signal includes at least two time slots per each information bit.

16. A receiver as claimed in claim 15, wherein the number of integrators at least equals the number of time slots.

17. A receiver as claimed in claim 15, wherein the time duration of each integrator belonging to the set of the at least two integrators equals the time duration of the time slot.

18. A receiver as claimed in claim 15, wherein the value of the information bit is indicated by having signal energy in one of the at least two timeslots.

19. A receiver as claimed in claim 12, wherein the receiver is configured to synchronize with the signal based on a preamble including a predetermined number of same information bits.

20. A receiver as claimed in claim 19, wherein the determining means is configured to conclude synchronization with the signal when the preamble has been detected.

21. A receiver as claimed in claim 19, wherein the determining means is configured to conclude the preamble to have been detected when a certain integrator has provided the highest output value more often during a predetermined number of bits than a predetermined threshold defines.

22. A receiver as claimed in claim 19, wherein the determining means is configured to conclude the preamble to have been detected when one of the at least two integrators provides a cumulative output value sum index during a predetermined number of bits higher than a predetermined threshold.
